(19) United States
(12) Patent Application Publication
(10) Pub. No.: US 2006/0176782 A1
(43) Pub. Date: Aug. 10, 2006

(54) Method and apparatus for recording/reproducing contents according to preset content ratings

(76) Inventor: Yun Hee Han, Pyungtaek-si (KR)

Correspondence Address: FLESHNER & KIM, LLP, P.O. BOX 221200, CHANTILLY, VA, 20153, US

(21) Appl. No.: 11/326,415

(22) Filed: Jan. 6, 2006

(30) Foreign Application Priority Data
Jan. 7, 2005 (KR) 10-2005-0001734

(51) Int. Cl. G11B 5/09

(52) U.S. Cl. 369/30.01; 369/47.1

(57) ABSTRACT

A method and apparatus for recording or reproducing broadcast programs according to maximum content rating set in a recording/reproducing apparatus is disclosed. When recording a broadcast program on a recording medium, the recording/reproducing apparatus optionally records the ID thereof and optionally the maximum content rating set therein on the recording medium together with the program. When reproducing a program recorded on a recording medium, the recording/reproducing apparatus determines whether to reproduce a program based on whether a reference content rating is higher than the content rating of the program.

This application claims priority to Korean patent application No. 10-2005-0001734, filed on Jan. 7, 2005, the entire contents of which is hereby incorporated by reference in its entirety.

### BACKGROUND OF THE INVENTION

1. Field of the Invention

The present invention relates to a method and apparatus for controlling the recording/reproduction of video signals such as broadcast programs according to content rating.

2. Background of the Related Art

Content ratings information is provided together with broadcast programs as auxiliary information to ensure that children are not exposed to violence or other contents intended for older viewers. Apparatuses for receiving broadcast signals (e.g., TVs, VCRs) allow users to set a maximum content rating in the apparatus so that inappropriate programs can be filtered out. When a maximum content rating is set, only programs which have content ratings equal to or lower than the maximum content rating can be viewed or recorded.

As the number of channels available in terrestrial, cable, and satellite broadcasts increases, viewers use the scheduled recording capability of their recording apparatus frequently. Scheduled recording allows a program to be recorded between start and stop times on defined days so that the viewer can view the recorded program at a convenient time. In the case where a TV is connected to the antenna through a recording apparatus, it is desirable to set the maximum content rating of the recording apparatus appropriately to keep children from watching violent or inappropriate programs.

If a program that is scheduled to be recorded has a content rating that exceeds the maximum content rating set in the recording apparatus, the scheduled program cannot be recorded. On the other hand, if the viewer sets the maximum content rating to a higher level to prevent such failed scheduled recordings, children may be exposed to inappropriate programs.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

To allow scheduled program recording when a maximum content rating is set in a recording apparatus, it is an object of the present invention to provide a method and apparatus that can block received programs based on their content ratings but also allow the recording of desired programs so that the recorded programs can be viewed later.

The method for recording a video signal on a recording medium by a recording apparatus according to the present invention records an input video signal on the recording medium, and also records the ID information of the recording apparatus and the content rating information set in the recording apparatus on the recording medium.

The method for reproducing a recorded video signal by a reproducing apparatus according to the present invention first determines if the video signal was recorded by the recording apparatus when reproduction of the video signal is requested and determines a reference content rating useable to determine whether to block the video signal by choosing either of the content rating set in the apparatus or the content rating recorded on the recording medium based on the first determination result.

In one embodiment of the recording method, a video signal is recorded on a recording medium as a program and the content rating set in the recording apparatus is recorded in a management information associated with the recorded program. The ID information of the recording apparatus is recorded in the management information allocated without regard to the recorded program.

In one embodiment of the reproduction method, a determination to determine whether a video signal recorded on a recording medium was recorded by the same recording/reproducing apparatus that is to reproduce the video signal will be based on the apparatus ID information recorded on the recording medium and the ID information of the recording/reproducing apparatus.

In one embodiment of the reproduction method, if it is determined that the video signal was recorded by the same recording/reproducing apparatus, the content rating set in the recording/reproducing apparatus is used as the reference content rating to determine whether to block the recorded video signal. If not, the content rating recorded on the recording medium is used as the reference content rating.

The objects and advantages can be achieved in a whole or in parts by a method for recording a video signal on a recording medium conducted by a recording apparatus, comprising: (a) recording an input video signal on the recording medium; and (b) recording ID information of the recording apparatus and content rating information set in the recording apparatus on the recording medium. Preferably, step (a) records the video signal on the recording medium without regard to the content rating of the input video signal. Preferably, step (b) records the content rating information in management information created corresponding to the recorded video signal.

The objects and advantages can be achieved in a whole or in parts by an apparatus for recording a video signal on a recording medium, comprising: a receiving unit for receiving the video signal; a recording unit for recording the received video signal on the recording medium; and a control unit for controlling the recording unit to record the video signal received by the receiving unit, ID information of the apparatus, and content rating set in the apparatus on the recording medium.

Preferably, the control unit controls the recording unit to record the content rating in management information created corresponding to the recorded video signal. Alternatively, on in addition to the control unit controls the recording unit to record the video signal on the recording medium without regard to the content rating of the received video signal.

The objects and advantages can be achieved in a whole or in parts by a method for reproducing a video signal recorded on a recording medium conducted by a reproduction apparatus, comprising: (a) comparing apparatus ID information recorded on the recording medium with the apparatus ID information of the reproduction apparatus when a request for reproduction of the video signal recorded on the recording medium is made; and (b) determining reference content rating to determine whether to block the video signal by choosing either of content rating information set in the reproduction apparatus or content rating information recorded on the recording medium based on the comparison result.

Preferably, the method further comprises comparing the reference content rating with the content rating of the selected video signal and outputting the recorded video signal based on the comparison result. Preferably, step (b) selects the content rating set in the reproduction apparatus as the reference content rating if the apparatus ID information recorded on the recording medium is equal to the apparatus ID information of the reproduction apparatus.

The content rating of the recorded video signal is recorded in management information associated with the recorded video signal. Alternatively, or in addition to the content rating of the recorded video signal is the content rating set in a recording apparatus that recorded the video signal on the recording medium. Alternatively, or in addition to step (b) selects the content rating recorded on the recording medium as the reference content rating if the apparatus ID information recorded on the recording medium is different from the apparatus ID information of the reproduction apparatus.

The objects and advantages can be achieved in a whole or in parts by a method for reproducing a video signal recorded on a recording medium conducted by a recording/reproduction apparatus, comprising: (a) determining if the recorded video signal was recorded by the recording/reproducing apparatus when a request for the reproduction of the recorded video signal is made; and (b) determining reference content rating to determine whether to reproduce the video signal by choosing either of content rating information set in the reproduction apparatus or content rating information recorded on the recording medium based on the comparison result.

The objects and advantages can be achieved in a whole or in parts by an apparatus for reproducing a video signal recorded on a recording medium, comprising: a reproduction unit for reading out the video signal and navigation information for the video signal from the recording medium; and a control unit for comparing apparatus ID information contained in the navigation information reproduced by the reproduction unit with apparatus ID information set in the apparatus and for determining reference content rating to determine whether to block the video signal by choosing either of content rating information set in the apparatus or content rating information contained in the navigation information based on the comparison result, when a request for the reproduction of the recorded video signal is made.

The control unit preferably outputs or blocks the recorded video signal by controlling the reproduction unit based on a comparison between the reference content rating and content rating of the recorded video signal. The content rating information is prefereably recorded in a part of the navigation information associated with the recorded video signal.

The content rating information is preferably the content rating set in a recording apparatus that recorded the video signal on the recording medium. Alternatively or in addition to the control unit preferably selects the content rating set in the apparatus as the reference content rating if the apparatus ID information contained in the navigation information is equal to the apparatus ID information set in the apparatus. Alternatively or in addition, the control unit preferably selects the content rating contained in the navigation information as the reference content rating if the apparatus ID information contained in the navigation information is different from the apparatus ID information set in the apparatus.

The objects and advantages can be achieved in a whole or in parts by an apparatus for reproducing a video signal recorded on a recording medium, comprising: a reproduction unit for reading out the video signal and navigation information for the video signal from the recording medium; and a control unit for determining if the recorded video signal was recorded by the apparatus and for determining reference content rating to determine whether to reproduce the video signal by choosing either of content rating information set in the reproduction apparatus or content rating information contained in the navigation information based on the determination result, when a request for the reproduction of the recorded video signal is made.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIGS. 1A and 1B illustrate block diagrams of optical disk recording/reproducing apparatuses in which the present invention may be advantageously embodied;

FIGS. 2A, 2B and 2C illustrate flowcharts of the methods for recording/reproducing programs based on content ratings in accordance with exemplary embodiments of the present invention;

FIGS. 3A and 3B illustrate exemplary menu screens for editing scheduled recordings;

FIG. 4 illustrates the relation between recorded video signals and navigation information therefor;

FIG. 5 illustrates the content rating information recorded in program information (PGI) for the recorded video signal in accordance with one embodiment of the invention; and

FIG. 6 illustrates the ID of the apparatus that recorded the video signal recorded in the video general management information table of navigation information in accordance with one embodiment of the invention.

### DETAILED DESCRIPTION OF PREFERRED EMBODIMENTS

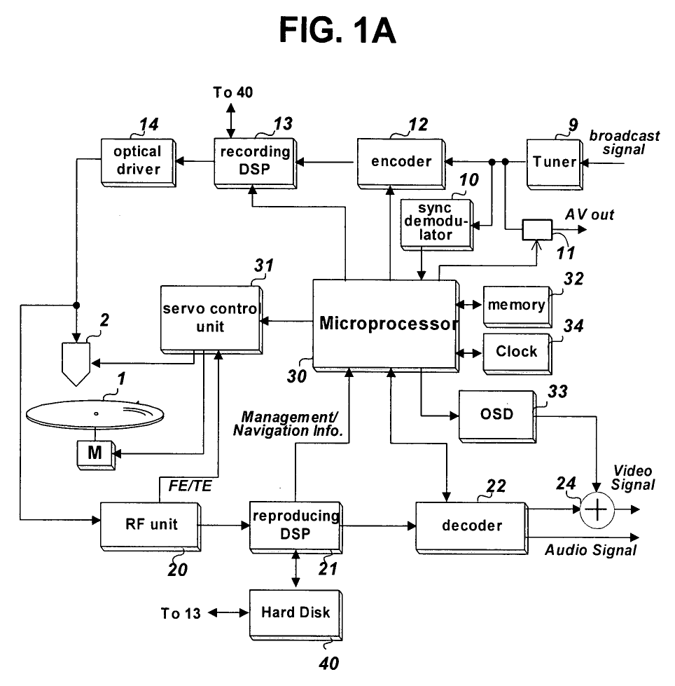

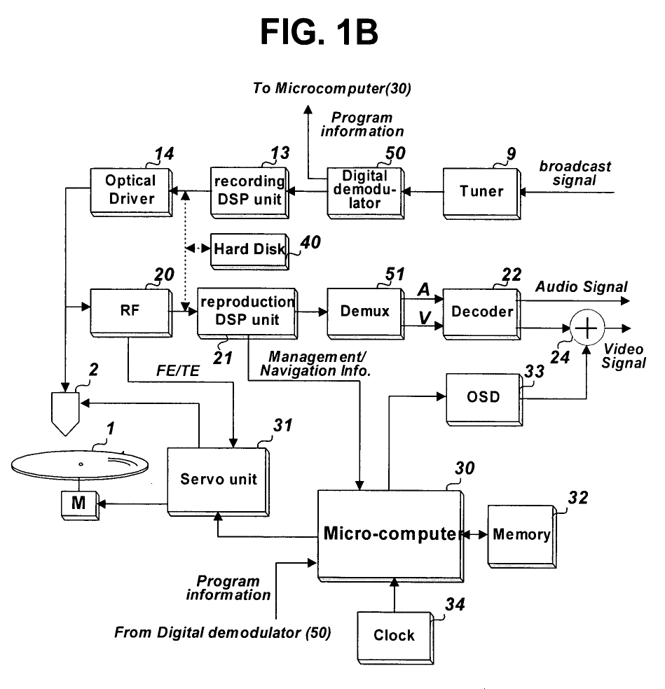

FIG. 1A is an exemplary block diagram of an optical disk recording/reproducing apparatus embodying the present invention. The recording/reproducing apparatus may have a recording function and/or a reproducing function. When the apparatus records, it may be optionally referred to as a recording apparatus. When the apparatus reproduces, it may be optionally referred to as a reproducing apparatus. The apparatus comprises a tuner 9, a sync demodulator 10, an encoder 12, a recording DSP 13, an optical driver 14, an optical pickup 2, an RF unit 20, a reproduction DSP 21, a decoder 22, an OSD unit 33, a mixer 24, a servo control unit 31, a memory 32, a clock unit 34, a microprocessor 30, and optionally a hard disk 40.

The tuner 9 tunes to a requested TV channel. The sync demodulator 10 detects data modulated in particular sync signals of the tuned broadcast signal. The encoder 12 digitizes the audio/video signals from the tuned channel, encodes the digitized signals in the MPEG format, converts the MPEG encoded data into PES (packetized elementary stream) packets, and multiplexes the PES packets into a single stream. The recording DSP 13 organizes the sequence of PES packets into the ECC block format and modulates the data for recording.

The optical driver 14 provides electrical current to the optical pickup 2 according to the signal from the recording DSP 13. The optical pickup 2 reads signals recorded on an optical recording medium 1, such as a DVD+/-R disk, and/or records signals from the optical driver 14 on the recording medium 1. The RF unit 20 generates binary signals and focusing and tracking error signals from the optical pickup 2. The reproduction DSP 21 retrieves digital data from the binary signals and extracts management information and navigation information from the retrieved digital data. The decoder 22 demultiplexes data from the reproduction DSP 21 into audio and video PES packets and decodes each of the PES packets to generate audio and video signals.

The OSD unit 33 generates character and graphic signals to be overlaid on the main video image. The mixer 24 mixes the video signal from the decoder 22 with the character and graphic signals from the OSD unit 33. The servo control unit 31 controls the optical pickup 2 using the focusing and tracking error signals, controls the laser beams, and controls a spindle motor for rotating the optical recording medium 1. The memory 32 stores navigation information and data required for the operation of the apparatus. In addition, the memory 32 stores an ID number for uniquely identifying the apparatus. The clock unit 34 keeps track of the current date and time. The microprocessor 30 deals with user input and supervises the operation of the apparatus.

A hard disk 40 is optionally positioned between the recording DSP 13 and the reproducing DSP 21, and the data maybe optionally recorded first on the hard disk 40, before the data is written on to the optical disk 1. The recording of the data may occur simultaneously, alternately, or alternatively on the optical disk 1 or the hard disk 40 or any other types of storage device capable of storing relatively large amounts of data.

FIG. 1B shows another embodiment of the optical disk recording/reproducing apparatus when the apparatus is to receive a digital broadcast signal. Components or circuits different from the apparatus of FIG. 1A, are a digital demodulator 50, and a demux 51. The embodiment of the apparatus that is to receive digital broadcast signal has a digital demodulator 50 for demodulating digital data streams, for example, transport streams from the tuned signal and examining header information of transport packets in the transport stream. The apparatus also contains a demux 51 for demuxing transport streams from the digital data into encoded audio/video streams and extracting management and navigation information from the digital data.

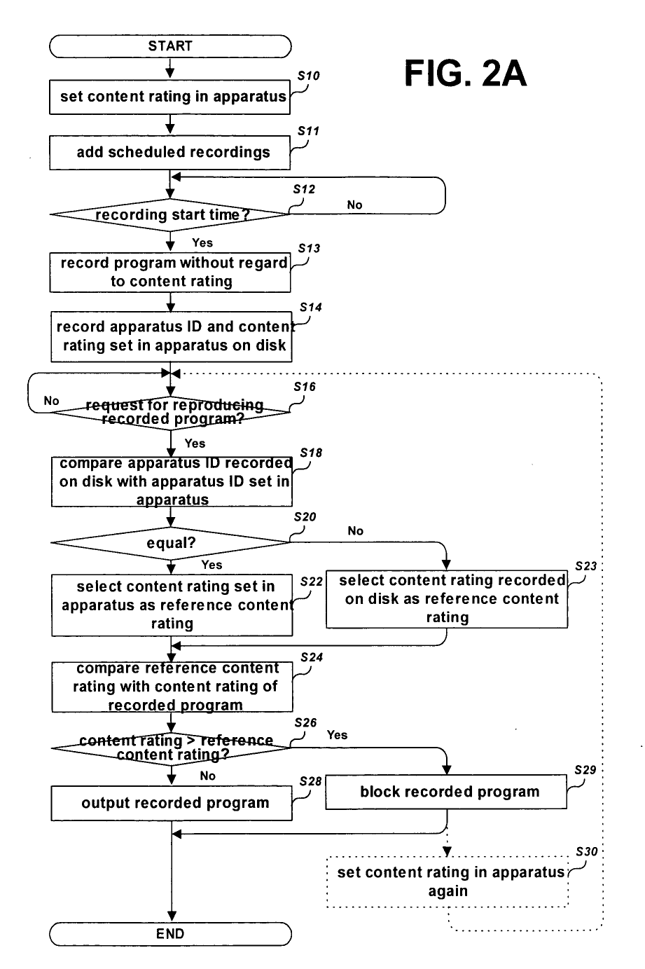

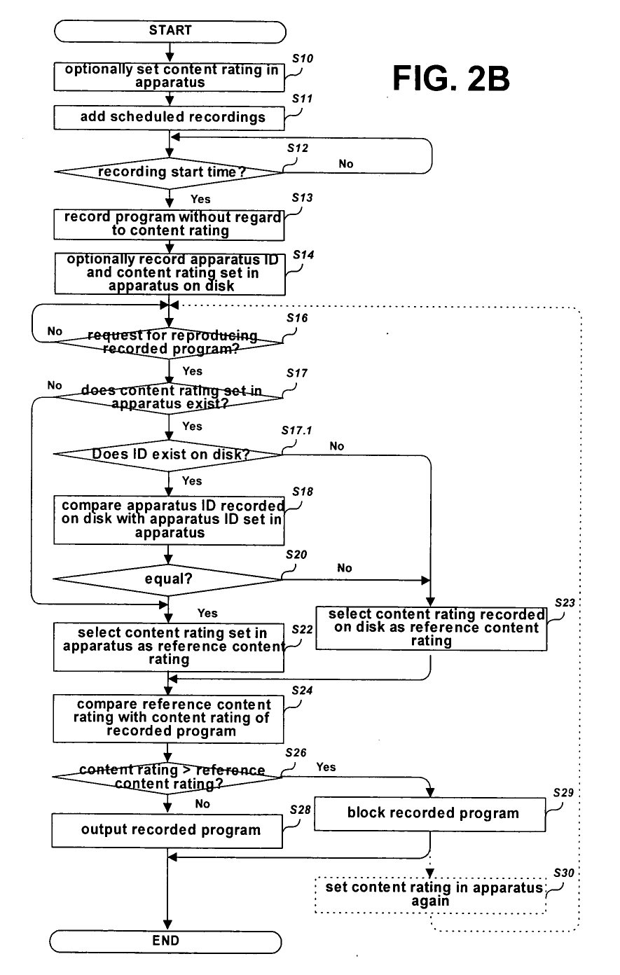

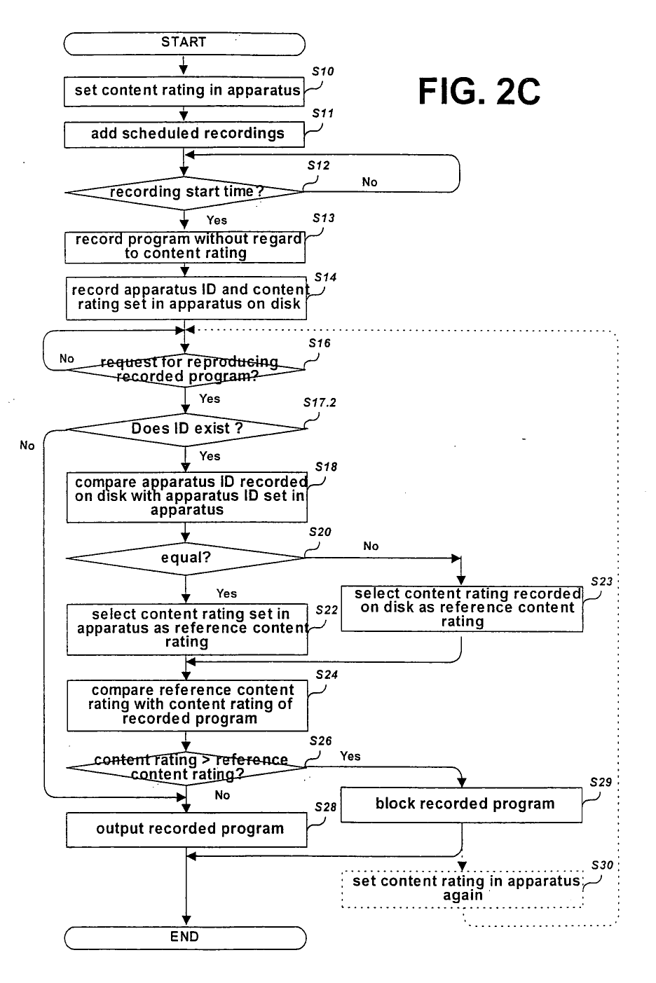

FIGS. 2A, 2B and 2C show exemplary flow diagrams of methods for this invention. In FIG. 2A, a user sets the content rating of an apparatus (S10). Thereafter, a user adds desired scheduled recordings into the apparatus using a scheduling menu (S11). Thereafter, the recording apparatus goes into hibernation mode or standby mode and continues to check if the recording start time is reached (S12). If the recording start time has not been reached, the operation loops. Otherwise, if the recording start time has been reached, the program is recorded without regard to the content rating (S13). Thereafter, the apparatus ID and the content rating set in the apparatus is recorded (S14).

Afterwards, a determination is made whether the user has requested to reproduce the recorded program (S16). If not, the process loops. Otherwise, if a request for reproducing the recorded program is received, the apparatus first compares the apparatus ID recorded on the disk with the apparatus ID of itself to determine if itself was the apparatus that was used to record the program on the disk (S18). If the apparatus IDs are equal (S20), the content rating currently set in the apparatus is selected as the reference content rating of the maximum viewable content. However, if the apparatus ID of the apparatus and the apparatus ID recorded on the disk does not match, the content rating that is recorded on the disk is accessed and selected as the reference content rating (S23). Thereafter, the selected reference content rating is compared with the content rating of the recorded program (S24). If the content rating of the recorded program is greater than the reference content rating, then the program is not reproduced (S29). Otherwise, if the content rating is not greater than the reference content rating, then the recorded program is reproduced (S28).

As an optional step, when the recorded program is not reproduced because the content rating of the recorded program is greater than the reference content rating, a user may choose to reset the maximum viewable content rating of the apparatus or even eliminate the content rating (S30), whereupon the process returns to step S16.

FIG. 2B shows another embodiment of the method. In this embodiment, steps S10 and S14 are optional. Further, compared to the method of FIG. 2A, the method of FIG. 2B includes the step of determining if a content rating set in the recording apparatus exists on disk (S17) and the step of determining if an apparatus ID of the apparatus exists on the disk (S17.1). If the content rating set in the recording apparatus does not exist on the disk, the operation continues to S22. Otherwise, if the content rating set in the recording apparatus does exist on the disk, the process continues to S17.1. In step 17.1, if the ID does exist, the process continues to S18 where the apparatus ID recorded on the disk is compared to the apparatus ID set in the reproducing apparatus. Otherwise, if the apparatus ID does not exist on the disk, then the operation continues to S23 where the content rating of the recording apparatus at the time of recording is used as the reference rating for a comparison with the program content rating.

FIG. 2C shows another embodiment of the method. Step not included in the method of FIG. 2A, which is included in the method of FIG. 2C, is step S17.2.

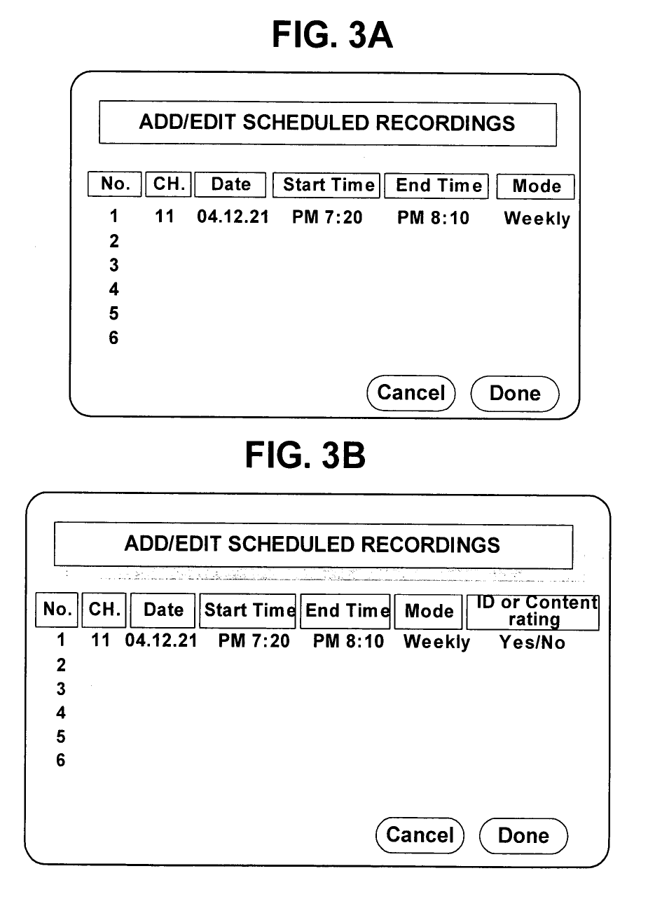

FIGS. 3A and 3B illustrate exemplary menu screens for editing scheduled recordings. The menu screen allows for entry of the channel information, the date information, the start time information, the end time information, as well as the mode of recording information, such as once, daily, weekly and so on. The menu screen has choices to cancel any added scheduled recording or confirming any scheduled recording. FIG. 3B is similar to the menu screen of FIG. 3A, but also includes a record ID and/or content rating choice to allow a user the option to record the apparatus ID and/or the content rating set in the apparatus to the disk.

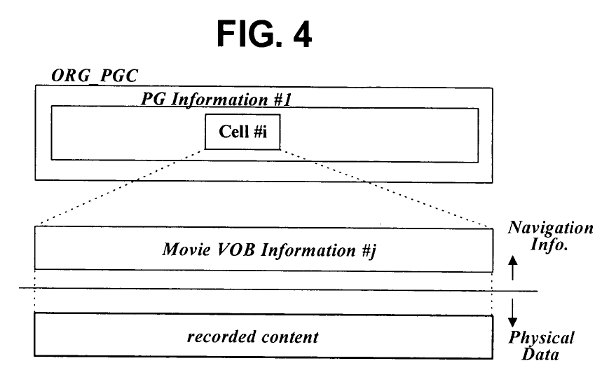

Exemplary methods of the invention will now be described using the flowchart shown in FIGS. 2A, 2B and 2C, in reference with the block diagrams shown in FIGS. 1A and 1B, the menu screens of FIGS. 3A and 3B, the data structures of FIGS. 4, 5 and 6.

Using input means such as a remote controller, a first user sets a desired content rating (PL_Set) in a recording/reproducing apparatus by choosing from available content ratings (e.g., 1 through 7) (S10). The chosen content rating (PL_Set) is stored in the memory 32. The content rating setting operation may be optionally followed by password confirmation to ensure that the first user is an authorized user who can modify the content rating of the apparatus. The signal from the remote controller, which is typically an infrared signal or alternatively RF signal, is received by infrared or RF receiving means and processed by the microprocessor 30.

If the first user selects the scheduled recording menu using the input means, the microprocessor 30 instructs the OSD unit 33 to output a scheduled recording menu screen as shown in FIGS. 3A or 3B. The first user enters information required for a scheduled recording such as, the channel, duration (start and end times including date), recording mode (e.g., one-time, daily, weekly, etc) on the menu screen using the remote controller (S11). Additional information, such as option to record apparatus ID or content rating may also be chosen (FIG. 3B).

If the first user selects “done” after entering all the necessary information, the microprocessor 30 adds the new scheduled recording to the list of scheduled recordings stored in the memory 32. After completing the settings for all required scheduled recordings, the first user turns off the recording/reproducing apparatus to put the apparatus in standby mode, wherein every component except for the components needed for checking time and receiving power on/off requests is inactivated. Thus, power consumption thereof is reduced significantly. In the standby mode, the microprocessor 30 keeps examining if the current date and time according to the clock unit 34 falls within the time period of one of the scheduled recordings (S12).

While in the standby mode, prior to the start of any prescheduled recording, a user may decide to watch a program. In such a case, a second user may turn on the recording/reproducing apparatus to watch a certain channel. When the recording/reproducing apparatus is turned on, and turned to the certain channel, the sync demodulator 10 first demodulates a 2-byte data modulated in particular horizontal sync signals included in vertical sync signals of the currently tuned channel's video signal and transmits the 2-byte data to the microprocessor 30. The microprocessor 30 keeps collecting the 2-byte data to form program auxiliary data that includes the content rating of the current program (Pr_PL) as well as the program time table of the tuned channel (FIG. 1A).

The microprocessor 30 then compares the content rating of the current program with the maximum content rating (PL_Set) set by the first user. If the content rating of the program exceeds the maximum content rating (PL_Set), it indicates that the current program is not supposed to be shown. Thus, the microprocessor 30 blocks the current program by controlling a semiconductor switch 11, thereby preventing the second user from viewing the program.

On the other hand, if the recording/reproducing apparatus remains in the standby mode, but if one of the scheduled recording sessions is about to start (S12), the microprocessor 30 puts the recording/reproducing apparatus in the normal mode and instructs the tuner 9 to tune to the channel to be recorded. In this case, the content rating of the program (Pr_PL) in the tuned channel is not taken into consideration, that is, the program is recorded unconditionally for now.

To record the program, the microprocessor 30 controls the servo control unit 31 so that the recording medium 1 rotates at a desired rotational speed and the optical pickup 2 moves to a location where the program will be recorded. Optionally, the microprocessor may control the hard disk 40 to record the program first to the hard disk. During recording, the video signal from the tuned channel is MPEG encoded and then organized into PES packets by the encoder 12. The PES packets are constructed into the ECC block format for error correction by the recording DSP 13 and recorded on the recording medium 1 by the optical driver 14 and optical pickup 2 after being modulated into signals appropriate for recording (S13), and optionally recorded on the hard disk 40. The microprocessor 30 transmits the content rating (Pr_PL) of the program that is being recorded to the encoder 12. The encoder 12 inserts the received content rating of the program (Pr_PL) in the header of the encoded data stream.

The recording operation continues until the end time of the scheduled recording is reached. If the end time is reached, the microprocessor 30 finishes the recording operation and updates the navigation information which was loaded into the memory 32 when the recording medium 1 was loaded so that the information pertaining to the newly recorded content (referred to as a program by the recording/reproducing apparatus) is added. The added information includes cell information for the recorded A/V section and program information (PG) that references the cell information. The original program chain information (ORG_PGC) is updated, too. If there is other necessary information, the information is added to the navigation information.

The navigation information data structure will be discussed in relation to FIGS. 4, 5 and 6. The navigation information is first held in the memory 32, modified after recording is complete, then written on to the disk 1 or hard disk 40 after its modification.

FIG. 4 illustrates a data structure for the relation between the recorded A/V content and the navigation information therefor. As shown, if program chain information (ORG_PGC) is designated, program information included therein is referenced. The cell information included in the program information specifies the recorded A/V section through M_VOB information. A piece of program information may include more than one piece of cell information. Likewise, the original program chain information may include multiple pieces of program information.

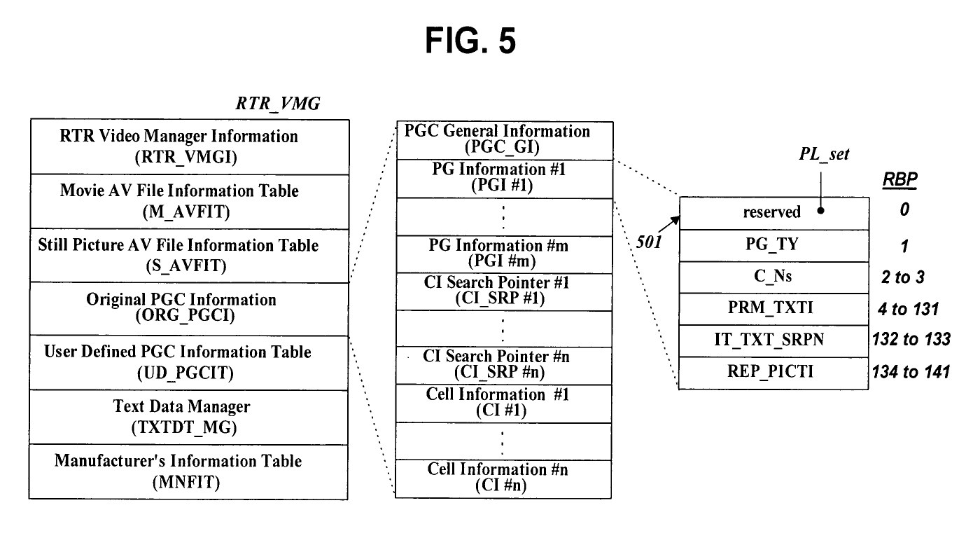

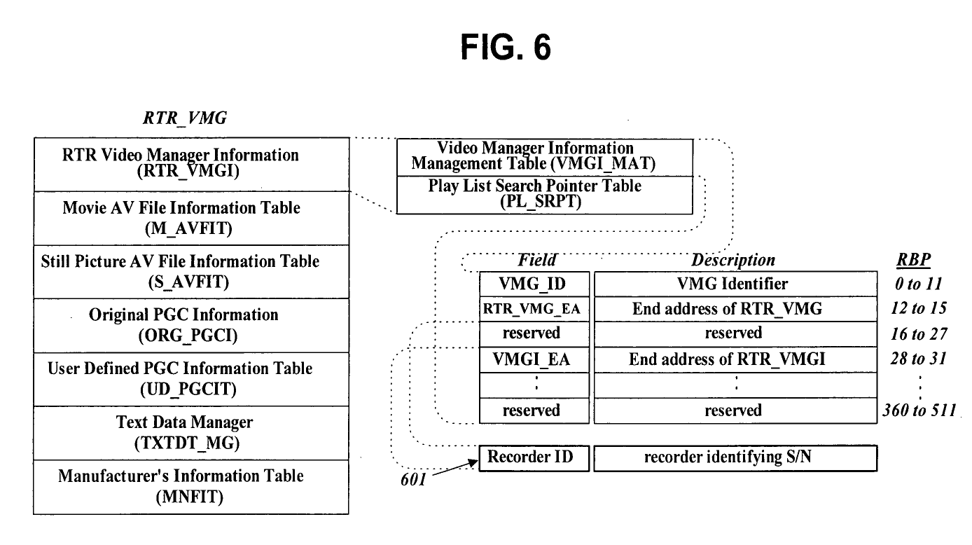

The navigation information that contains the program information has a structure shown in FIG. 5. The microprocessor 30 records the maximum content rating (PL_Set) stored in the memory 32 in a 1-byte field 501 reserved in the program information created for the recorded program. FIG. 6 shows the navigation information that contains the video general management information. As shown in FIG. 6, the microprocessor 30 writes the ID number of the recording/reproducing apparatus stored in the memory 32 in the 12-byte reserved field 601 (RBP16 through RBP27) of the video general management information table (VMGI_MAT) of the navigation information that has been loaded in the memory 32 in the ASCII format. If the length of the ID number exceeds 12 bytes, only the least significant 12 bytes are written.

Therefore, the maximum content rating (PL_Set) set by the user and the ID number of the recording/reproducing apparatus are written in different areas of the navigation information. The reason that the maximum content rating (PL_Set) set by the user is not written in the general management information table but in the program information associated with the recorded program is that the maximum content rating set in the apparatus may differ each time a program is recorded on the recording medium 1, or the hard disk 40

After updating the navigation information loaded in the memory 32, the microprocessor 30 may instruct the servo control unit 31 to record the updated navigation information in the navigation information area on the recording medium 1 through the recording DSP 13 and the optical pickup 2 (S14), or alternatively, to the hard disk 40. It is also possible to record the navigation information on the recording medium 1 when a request for ejecting the recording medium 1 is made.

The method for reproducing the recorded program based on the ID numbers of the recording and the reproducing apparatuses, the maximum content rating recorded in the disk and set in the reproducing apparatus, and the content rating of the recorded program on the disk will be discussed using FIGS. 2A and 2B, in relation to FIGS. 3A, 3B, 4, 5 and 6.

When the first user issues a command for requesting the list of contents (programs) recorded on the recording medium 1 after the scheduled recording session is completed, the microprocessor 30 constructs the list of recorded programs with reference to the original program chain information (ORG_PGC) of the navigation information that has been loaded in the memory 32, and outputs the list on the screen through the OSD unit 33.

If the first user selects one program from the menu screen and requests reproducing of a recorded program (S16), the microprocessor 30 reads the ID number recorded in the video general management information table (VMGI_MAT) (as shown in FIG. 6) from the navigation information that has been loaded into the memory 32 and compares the ID number of the recording apparatus from the disk with the ID number (or the least significant 12 bytes) of the reproducing apparatus which is stored in the memory 32 (S18). If the two ID numbers are equal (S20), the microprocessor 30 uses the maximum content rating stored in the memory 32 of the reproducing apparatus as the reference rating to determine whether to block the selected program (S22). On the other hand, if the two ID numbers are not equal, the microprocessor 30 uses the content rating recorded in the field 501 reserved in the program information for the selected program shown in FIG. 5 as the reference rating to determine whether to block the selected program (S23) (i.e., content rating that was set in the recording apparatus, and which has been recorded on the disk). The procedure is described below in detail.

After setting the reference rating, the rating of the program is obtained from the disk, which is then compared with the reference rating to determine whether to block reproduction of the recorded program. With reference to the navigation information having link information as shown in FIG. 4, the microprocessor 30 instructs the servo control unit 31 to move the optical pickup 2 to the location where the program is recorded, or instructs the hard disk 40 to start a read operation therefrom. The high frequency signal read by the optical pickup 2 is converted to a digital data stream by the RF unit 20 and the reproduction DSP 21 and then decoded into A/V signals by the decoder 23.

Receiving the content rating (Pr_PL) of the program, which is recorded in the header of the digital data stream and decoded by the decoder 23, the microprocessor 30 compares the content rating with the reference content rating chosen by the aforementioned method (S24). If the content rating (Pr_PL) of the program is higher than the reference content rating (S26), the microprocessor 30 makes the decoder 23 stop A/V decoding (S29) and outputs a message on the screen indicative of the reason for the stopped A/V decoding through the OSD unit 33. On the other hand, if the content rating (Pr_PL) of the program is lower than the reference content rating, the decoder 23 continues the decoding operation (S28).

When the A/V decoding is stopped due to the content rating of the program (Pr_PL) being higher than the reference content rating, the first user has the option to change the maximum content rating of the reproducing apparatus, that has the same ID information as the recording apparatus. Thus, the first user, who is authorized to change the maximum content rating of the recording/reproducing apparatus, sets the maximum content rating to a value higher than the content rating (Pr_PL) of the recorded program which the first user wants to view (S30), the recording/reproducing apparatus shows the recorded program. The second user, however, has no right to change the maximum content rating because he lacks the needed password, for example, and thus cannot view the programs recorded on the recording medium 1 in this case.

If the second user tries to circumvent the block and tries to reproduce the recording medium 1 using another recording/reproducing apparatus, then the ID number recorded on the recording medium 1 is different from the ID number of the new recording/reproducing apparatus. In this case, the content rating recorded on the recording medium 1 (i.e., the content rating set in the recording apparatus) is used as the reference content rating (S23) because of the different ID numbers, as discussed above. In this case, if the reference content rating, which is the content rating set in the apparatus that recorded the program, is less than the content rating of the recorded program, the recording/reproducing apparatus does not decode the recorded program. As a result, the second user still cannot view the recorded program even using other recording/reproducing apparatuses.

Another exemplary method of blocking viewing of recorded programs will be discussed in reference to FIG. 2B. Steps that are in FIG. 2B, but which are different from FIG. 2A, are an optional step of setting the content rating in recording apparatus (S10), an optional step of recording the ID number of the recording apparatus and/or the content rating set in the recording apparatus, (S14), a step of determining whether an ID number of the recording apparatus exists on the disk (S17.1) and a step of detemining whether a content rating set in the apparatus exists on the disk (S17).

When a first user uses the recording/reproducing apparatus, the first user may optionally choose not to set the content rating in the apparatus. Therefore, in this embodiment, step S10 is omitted. Additionally, or alternatively, the first user may choose not to include the ID number of the recording apparatus on the disk. A menu allowing the first user to select or not select the ID recording function is shown in FIG. 3B. If the first user selects “NO” on the ID number recording or otherwise decides not to include the ID number of the recording apparatus, then the ID number of the recording apparatus will not be included in the disk. Therefore, the first user may choose to include or exclude either or both of the ID number or the content rating set in the apparatus (PL_Set) from the disk.

During the reproducing operation by the reproducing apparatus, after a request for reproducing the recorded program is made by a user (S16), a determination is made whether the content rating set in the apparatus exists on the disk (S17). If the content rating does not exist, then the content rating set in the reproduction apparatus is set as the reference content rating (S22). However, if the content rating does exist, then a further determination is made to determine whether an ID number of the recording apparatus exists on the disk (S17.1). If the ID number of the recording apparatus does not exist, then the content rating of the recording apparatus recorded on the disk is selected as the reference content rating (S23).

In another exemplary embodiment, the first user may select not to record the ID number of the recording/reproducing apparatus on the disk 1. FIG. 2C shows the exemplary method. Steps that are in FIG. 2C, which are not in FIG. 2A is a step for determining whether an ID number exists (S17.2), after the step of requesting reproduction of the recorded program (S16). As shown in FIG. 2C, if it is determined that an ID number exists, then the apparatus ID recorded on disk is compared with the ID of the reproducing apparatus (S18). However, if it is determined that an ID number does not exist, then the program on the disk is reproduced (S28), without any content rating determination.

FIG. 3B shows the exemplary menu screen that may be used to not record the ID number and/or set the content rating of the recording apparatus. The menu screen of FIG. 3B offers to the user a choice whether to include the ID number and/or set the content rating. If the ID number is not included and/or the content rating is not set, then the disk may be played on a reproducing apparatus freely, as shown in FIG. 2C.

The method according to the present invention allows one user, such as a parents to set a maximum content rating of a recording/reproducing apparatus with a view to preventing another user, such as children from watching programs having content rating higher than the maximum content rating set by the parents but also allows programs having higher content ratings to be recorded. The recorded programs can be viewed by the parents but the children are still not allowed to view the recorded programs.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for recording a video signal on a recording medium by a recording apparatus, comprising:
recording an input video signal on the recording medium regardless of a content rating of the input video signal; and
recording ID information of the recording apparatus; and
recording a content rating information set in the recording apparatus on the recording medium.

2. The method set forth in claim 1, wherein the step of recording ID information of the recording apparatus records the content rating information in management information created corresponding to the recorded video signal.

3. An apparatus for recording a video signal on a recording medium, comprising:
a receiving unit for receiving the video signal;
a recording unit for recording the received video signal on the recording medium; and
a control unit for controlling the recording unit to record the video signal received by the receiving unit, ID information of the apparatus, and content rating set in the apparatus on the recording medium, wherein the control unit controls the recording unit to record the video signal on the recording medium regardless of the content rating of the received video signal.

4. The apparatus set forth in claim 3, wherein the control unit controls the recording unit to record the content rating in management information created corresponding to the recorded video signal.

5. A method for reproducing a video signal recorded on a recording medium by a reproducing apparatus, comprising:
comparing apparatus ID information recorded on the recording medium with the apparatus ID information of the reproducing apparatus when a request for reproduction of the video signal recorded on the recording medium is made; and
choosing either of a content rating information set in the reproducing apparatus or a content rating information recorded on the recording medium as a reference content rating for use in a comparison to determine whether to block the video signal based on the comparison result.

6. The method set forth in claim 5, further comprising:
comparing the reference content rating with the content rating of the selected video signal and outputting the recorded video signal based on the comparison result.

7. The method set forth in claim 6, wherein the reference content rating is greater than the recorded video signal.

8. The method set forth in claim 5, wherein the content rating of the recorded video signal is recorded in management information associated with the recorded video signal.

9. The method set forth in claim 5, wherein the content rating is the content rating set in a recording apparatus that recorded the video signal on the recording medium.

10. The method set forth in claim 5, wherein the content rating set in the reproducing apparatus is chosen as the reference content rating if the apparatus ID information recorded on the recording medium is equal to the apparatus ID information of the reproducing apparatus.

11. The method set forth in claim 5, wherein the content rating recorded on the recording medium is chosen as the reference content rating if the apparatus ID information recorded on the recording medium is different from the apparatus ID information of the reproducing apparatus.

12. A method for reproducing a video signal recorded on a recording medium by a recording/reproduction apparatus, comprising:
determining if the recorded video signal was recorded by the recording/reproducing apparatus when a request for the reproduction of the recorded video signal is made;
choosing either of a content rating information set in the reproduction apparatus or a content rating information recorded on the recording medium as a reference content rating; and
determining whether to block the reproduction of the recorded video signal based on a comparison of the reference content rating and a content rating information of the recorded video signal.

13. An apparatus for reproducing a video signal recorded on a recording medium, comprising:
a reproduction unit for reading out the video signal and a navigation information for the video signal from the recording medium; and
a control unit for comparing an apparatus ID information contained in the navigation information reproduced by the reproduction unit with an apparatus ID information set in the apparatus, and for choosing either of a content rating information set in the apparatus or a content rating information contained in the navigation information as a reference content rating for use in a comparison to determine whether to block the reproduction of the video signal based on the comparison result, when a request for the reproduction of the recorded video signal is made.

14. The apparatus set forth in claim 13, wherein the control unit outputs or blocks the recorded video signal by controlling the reproduction unit based on a comparison between the reference content rating and the content rating of the recorded video signal.

15. The apparatus set forth in claim 14 wherein the recorded video signal is output if the reference content rating is equal to or higher than the content rating of the recorded video signal, and the recorded video signal is blocked if the reference content rating is lower than the content rating of the recorded video signal.

16. The apparatus set forth in claim 13, wherein the content rating information is recorded in a part of the navigation information associated with the recorded video signal.

17. The apparatus set forth in claim 13, wherein the content rating information is the content rating set in a recording apparatus that recorded the video signal on the recording medium.

18. The apparatus set forth in claim 13, wherein the control unit chooses the content rating set in the apparatus as the reference content rating if the apparatus ID information contained in the navigation information is equal to the apparatus ID information set in the apparatus.

19. The apparatus set forth in claim 13, wherein the control unit chooses the content rating contained in the navigation information as the reference content rating if the apparatus ID information contained in the navigation information is different from the apparatus ID information set in the apparatus.

20. An apparatus for reproducing a video signal recorded on a recording medium, comprising:
a reproduction unit for reading out the video signal and a navigation information for the video signal from the recording medium; and
a control unit for determining if the recorded video signal was recorded by the apparatus, and for choosing either of a content rating information set in the reproduction apparatus or a content rating information contained in the navigation information as a reference content rating to determine whether to produce the video signal, when a request for the reproduction of the recorded video signal is made.

21. A method of reproducing a video signal recorded on a recording medium by a reproducing apparatus, comprising:
determining whether a content rating is recorded on the recording medium, wherein the content rating is the content rating set in the recording apparatus during recording of the video signal; and
reproducing the video signal if it is determined that the content rating is not recorded on the recording medium.

22. The method of claim 21, further comprising:
determining whether an apparatus ID of the recording apparatus is recorded on the recording medium; and
reproducing the video signal if it is determined that the apparatus ID is not recorded on the recording medium.

23. A method for at least one of recording information on a recordable medium by a recording/reproducing apparatus or reproducing recorded information, comprising:
setting a parental control information to a first prescribed level on the recording apparatus;
allowing the apparatus to record information for a prescribed period of time;
recording the information having a parental control information of a second prescribed level on the recordable medium during the prescribed period of time even if the second prescribed level is higher than the first prescribed; and
recording information corresponding to an identification information of the recording apparatus, the first prescribed level and the second prescribed level on the recordable medium.

24. The method of claim 23, wherein if the recording/reproducing apparatus is used for reproducing the recorded information on the recordable medium such that recorded identification information on the recordable medium is the same as identification information of the recording/reproducing apparatus,
comparing the recorded second prescribed level to a current parent control information of the recording/reproducing apparatus; and
reproducing the recorded information if the current parent control information of the recording/reproducing apparatus is at least equal to the recorded second prescribed level.

25. The method of claim 24, wherein if the current control information is less than the recorded second prescribed level, blocking a reproduction of the recorded information.

26. The method of 25, if the current control information is less than the recorded second prescribed level, allowing a change to the current control information to be at least equal to the recorded second prescribed level.

27. The method of 23, wherein the identification information is recorded on the recordable medium if the recording/reproducing apparatus has been programmed for recording such an information during the recording step.
